(19) United States
(12) Patent Application Publication
(10) Pub. No.: US 2014/0100864 A1
(43) Pub. Date: Apr. 10, 2014

(54) PATIENT REIMBURSEMENT SYSTEMS

(71) Applicant: Korb Matosich, South Jordan, UT (US)

(72) Inventor: Korb Matosich, South Jordan, UT (US)

(21) Appl. No.: 14/037,866

(22) Filed: Sep. 26, 2013

Related U.S. Application Data
(60) Provisional application No. 61/709,375, filed on Oct. 4, 2012.

(51) Int. Cl. G06F 19/00

(52) U.S. Cl. CPC G06F 19/328
USPC 705/2

(57) ABSTRACT

Validating services received and prices paid by a patient. A patient user interface is presented, which is configured to enable a patient to enter patient information relative to medical services received by the patient in connection with one or more visits by the patient to a medical provider. Patient information is received at the patient user interface. The patient information includes an identity of at least one service provided to the patient by the medical provider, and a price paid by the patient to the medical provider in connection with the medical provider providing the at least one service to the patient. It is determined whether or not the price paid by the patient is applicable toward a deductible for the patient's insurance plan, and/or whether or not all or part of the price paid by the patient is applicable toward a patient reimbursement based on the patient's insurance plan.

### CROSS REFERENCE TO RELATED APPLICATIONS

This application claims priority to and the benefit of U.S. Provisional application 61/709,375, filed Oct. 4, 2012, and titled “PATIENT REIMBURSEMENT SYSTEMS,” which provisional application is incorporated herein by reference in its entirety.

### BACKGROUND

U.S. spending on health care represented over 17.6% of U.S. GDP or over $8,000 per person in 2011. This is more than one and a half times the spending level of any other developed nation on healthcare. While health care costs increased only 1% in 2012 (the first time inflation outpaced health care spending growth since the 1960s), healthcare costs are already insupportably high and spending growth will likely accelerate again in the future. Over the last 30 years, health care spending has grown approximately two percentage points faster than the rate of overall economic growth, and long-term forecasts are consistent with that historical trend.

The high and increasing cost of health care in the U.S. creates problems for all participants in the health care system. For individuals with insurance, the rising cost of health care is paid for in some combination of higher insurance premiums, deductibles, and co-pays. Those who lack insurance directly pay for the rise in health care costs, or they are forced to forego health care altogether.

Administrative burdens for health care providers continue to climb as payers implement new programs or controls to attempt to reign in rapidly increasing health care costs. Providers generally must work with multiple insurers—each having different rate structures and paperwork requirements. As a result, it is not unheard of for health care providers to spend as much as 30% of their revenues on insurance-related administration and overhead.

In addition, third-party payers face significant regulatory uncertainty as the federal and state governments attempt to “reform” health care so that expenses can be brought under control. Third-party payers have also made independent efforts to control costs by investing millions in complex systems and programs meant to better “manage care,” but most of these initiatives have proved ineffective at bending the rising trend of health care expenditures.

For most complex purchases (e.g. automobiles), solution-oriented markets support a powerful consumer who drives a competitive marketplace where information is transparent and where price points tend to decline over time. Healthcare is different; largely as a result of how we pay for healthcare, consumerism is almost completely absent from that marketplace. In fact, health care doesn't really behave like a market at all. The health care payment model is designed to minimize insurer risk, not empower consumers. Many patients never learn the true cost of their health care. The principal reason patients do not know prices before receiving care is because the cost of health care is usually paid directly by third-party payers and not by the patients themselves. As a result doctors and hospitals do not compete for patients based on price and prices have steadily increased.

Price and quality competition seem to be connected—an efficient pricing market appears to be a precursor to plentiful quality information. When market players are compelled to compete on price, they tend to actively seek out ways to differentiate themselves from their competitors to avoid becoming commodities. Quality transparency becomes a key factor in that race to differentiate: when providers do not compete on price, they generally do not compete on quality either.

As noted in the NCPA Policy Report No. 296 (2007), in the lack of competition for patients among health care providers has had a profound effect on the quality and cost of health care. Long before a patient enters a doctor's office, third-party bureaucracies have already determined which medical services they will pay for, which medical services they will not pay for, and how much they will pay. The result is a highly artificial market, which departs in many ways from how other markets function, and that has experienced continual cost increases well above the rate of overall economic growth.

There are some health care markets in which third-party payers do not negotiate prices or pay the bills, and these markets behave in a radically different fashion. In the market for cosmetic surgery, for example, patients are offered package prices covering all aspects of care, including physician fees, ancillary services, facility costs and so forth. Not only is there price competition for cosmetic surgery, but also the real price of cosmetic surgery has actually declined over the past 15 years—despite a six-fold increase in demand and enormous technological change. Similarly, the price of conventional LASIK vision correction surgery (for which patients pay with their own money) has fallen dramatically, even as procedures become more technically advanced.

Retail walk-in clinics in drugstores, shopping malls and big-box retailers are another example. Originally established to bypass traditional health insurance, they post prices for procedures up-front, and minimize waiting times. They are generally staffed by nurse practitioners and use computer software to follow treatment protocols. Their medical records are generally stored electronically and they generally permit prescriptions to be ordered online. Their quality of care is often higher than the care provided by non-retail establishments because the technologies they use encourage best practices, improve care coordination, reduce errors, and prevent adverse drug interactions.

Like walk-in clinics, a growing number of medical practices are beginning to offer discounts for patients who pay bills directly, and who avoid use of third-party insurance. These entities almost always post their prices, and many store records electronically and offer e-mail and telephone consultations.

Given the contrast in health care cost trends between markets where third-party payers are financially responsible vs. where they are not, consumer decision making clearly creates a competitive dynamic that drives improved quality and efficiency and results in lower health care expenditures. However, it has been difficult to create truly competitive markets for most healthcare services due to the need to have a third-party insurer provide protection in the event of a significant or even catastrophic adverse health event or illness. While high deductible health plans have introduced an element of consumerism into the consumption of health care services, these plans have been built on the same contracts, networks, and payment systems as legacy insurance plans. As such, consumers have been hindered in their attempts to make value-based purchase decisions.

An engaged, informed consumer leads to a lower cost, more efficient, and more competitive health care marketplace. However, until pricing power is taken from third-party payers and given to patients, patients will generally not act as consumers and be engaged in health care cost reduction activities.

### BRIEF SUMMARY

Embodiments herein are directed to a health care payment system that enables patients to shop for health care services based on price and quality, and that drives market competition. Embodiments herein preserve the traditional insurance safety net in the event of major health care expenses, but allow consumers to pay at the time of service—without the need for a provider to submit a claim to any plan administrator. On one hand, since patients pay at the time of service, the embodiments herein encourage patients to be actively involved in decisions related to the cost of healthcare. On the other hand, since providers are able to eliminate the administrative overhead associated with health care transactions relating to patients who pay in full at the time of service (i.e. eliminating claims), providers are encouraged to provide services at substantially discounted rates to such patients who pay in full at the time of service.

In addition to preserving the protective elements of insurance in catastrophic cases, the embodiments herein also eliminate a new type of consumer fraud that would have the potential to emerge, in which patients claim to have received and paid for health care services that they, in fact, have not received or paid for. As such, the embodiments herein provide unique combinations of billing and patient reimbursement systems for medical related expenses which reduce or eliminate the administrative burden on health care providers to submit claims for reimbursement, and which also provide mechanisms for identifying potential fraud.

Embodiments include a method for validating services received and prices paid by a patient. A patient user interface is presented. The patient user interface is configured to enable a patient to enter patient information relative to medical services received by the patient in connection with one or more visits by the patient to a medical provider. Patient information is received at the patient user interface. The patient information includes an identity of at least one service provided to the patient by the medical provider, and a price paid by the patient to the medical provider in connection with the medical provider providing the at least one service to the patient. Based on the patient information, it is determined whether or not the price paid by the patient is applicable toward a deductible for the patient's insurance plan and/or whether or not all or part of the price paid by the patient is applicable toward a patient reimbursement based on the patient's insurance plan.

These and other objects and features of the present invention will become more fully apparent from the following description, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates exemplary acts in a computer-implemented method for validating services received and prices paid by patients, and for validating provider pricing compliance with network contracts;

FIG. 2 illustrates one or more additional acts that may be performed as part of accessing information about services received and prices paid in connection with a recent provider visit or series of visits;

FIG. 3 illustrates one or more additional acts that may be performed as part of accessing information from alleged provider(s) about alleged services delivered and prices paid in connection with a recent visit or series of visits entered by a patient;

FIG. 4 illustrates one or more additional acts that may be performed as part of reconciling patient supplied information with provider-supplied information;

FIG. 5 illustrates one or more additional acts that may be performed as part of flagging a patient group of services that has failed validation for follow-up so that discrepancies can be resolved;

FIG. 6 illustrates one or more additional acts that may be performed as part of routing a patient group of services that has been validated to a plan administrator for further processing;

FIG. 7 illustrates one or more additional acts that may be performed as part of comparing the price charged by provider(s) with an established price in a network contract to ensure that it is less than or equal to the network price;

FIG. 8 illustrates an example flow diagram for validating services received and prices paid by patients, and for validating provider pricing compliance with network contracts, and which does not require provider claim submission or provider claim validation;

FIG. 9 illustrates an example user interface for entry of patient visit information; and

FIG. 10 illustrates an example user interface that presents visit summary information.

### DETAILED DESCRIPTION

Embodiments herein are directed to methods, systems, and storage devices that facilitate patients paying for services at the time of service, while preserving insurance safety nets for excessive health care expenses. Embodiments herein provide mechanisms for reimbursing a patient for fees paid in excess of a deductible, without requiring a provider to submit a claim to any plan administrator. Embodiments herein can also be used to identify and help prevent consumer fraud that may be enabled by health care systems that allow patients to pay for services up front, by actively engaging both the patient and the provider to validate the services delivered and the prices paid. Among other things, the embodiments herein can be used to increase consumer involvement, to lower the cost of health care, to reduce the cost of administrative compliance by health care providers, and to reduce the incidence of fraud, waste and abuse.

Conventional systems and methods for determining an appropriate level of payment to providers and preventing health care fraud, waste and abuse do not include any meaningful amount of patient involvement. Typically, most payments to providers are the result of a submitted claim that is priced solely based on a provider's report of diagnoses and services and the negotiated rates specified in the provider network contract. Furthermore, conventional fraud, waste and abuse prevention systems and methods rely solely on information included on the submitted health care claim and information stored in databases of claims history and/or algorithms derived from claims history to identify inconsistencies or other indicators that the claim is invalid, duplicative, in error, or fraudulent. None of these processes encourage patient involvement to drive competition in the health care marketplace or to validate that a legitimate, covered service was actually delivered.

Since the embodiments herein encourage consumers to pay their provider at time of service, the embodiments herein can eliminate the need for providers to code and submit claims for payment, and to wait for payment or struggle with collections of monies owed. As such, significant administrative savings can be achieved while simultaneously engaging the patient as a cost-conscious consumer in the health care decision making process. By placing a greatly simplified administrative burden on the patient, and by engaging the patient and the provider to validate the services delivered and price paid, adequate tracking of health care service delivery can be achieved while reducing the incidence of fraud, waste, and abuse in the system.

According to one or more embodiments, a patient pays for health care services at the time of service, and is enabled to report that payment for credit of the payment toward his or her insurance deductible, and/or to obtain reimbursement for any fees that exceed his or her insurance deductible requirements. After a validation is made to ensure that information associated within the patient's request is consistent with service information identified by the provider, the patient's credit/reimbursement can be applied/paid. In some embodiments, the validation process is also used to detect potential fraud and to trigger follow-up processes.

According to some embodiments, a medical billing and reimbursement model may have one or more of the following attributes:

1. Consumer pays at time of service.
2. A computer-based tool or other means of electronic exchange is provided for the consumer to submit visit summary information to a plan administrator.
3. A computer-based tool or other means of electronic exchange is provided for a medical provider to submit visit summary information to the plan administrator.
4. The plan administrator is enabled to validate services delivered and price paid by consumer via a computer-based tool or other means of electronic exchange.
5. Confirmed visit summary information is used to determine whether a delivered service is covered, to update the consumer's remaining deductible calculation and/or reimburse consumer for monies paid beyond the deductible.

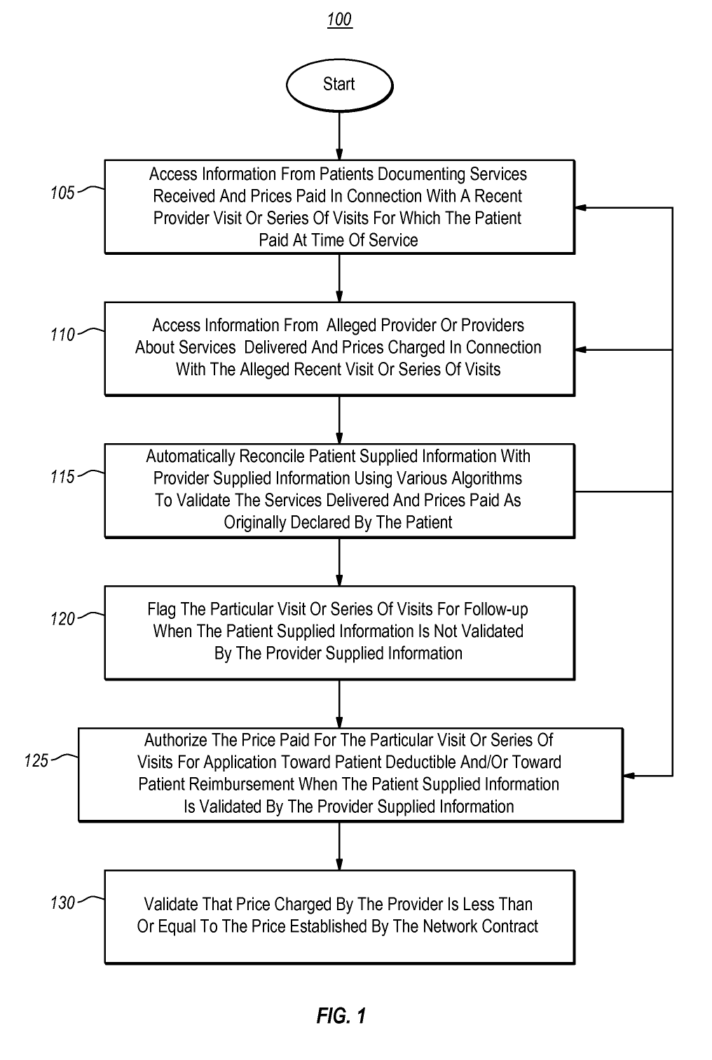

To further illustrate the foregoing, FIG. 1 illustrates exemplary acts in a computer-implemented method 100 for validating services received and prices paid by patients, and for validating provider pricing compliance with network contracts. It will be appreciated that not all of the depicted acts have to occur in the order shown, as will be apparent to persons skilled in the relevant art(s) based on the teachings herein. Other operational and structural embodiments will be apparent to persons skilled in the relevant art(s) based on the following discussion.

In an act 105, information is accessed from patients about services received and prices paid in connection with a recent provider visit or series of visits. For example, when a patient has visited a doctor and paid at the time of service and desires the amount paid to be applied against his/her deductible or desires to be reimbursed for the expense, the patient may enter into the system information describing the recent visit.

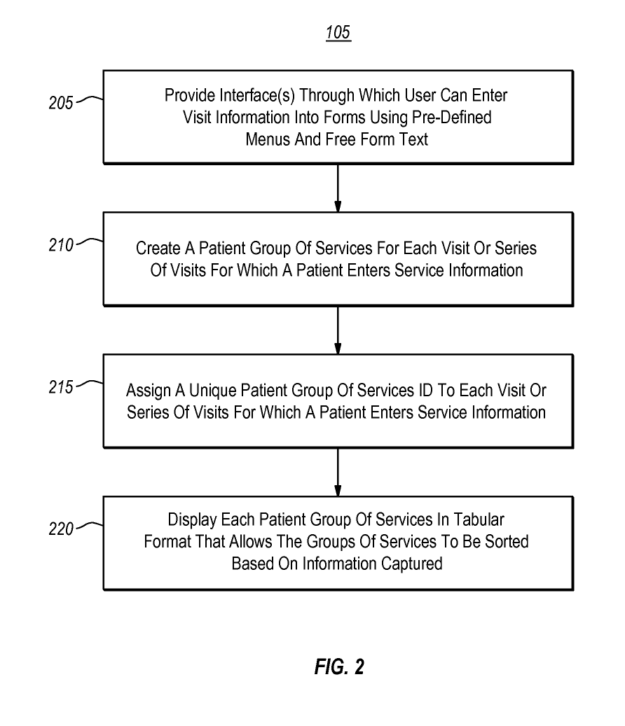

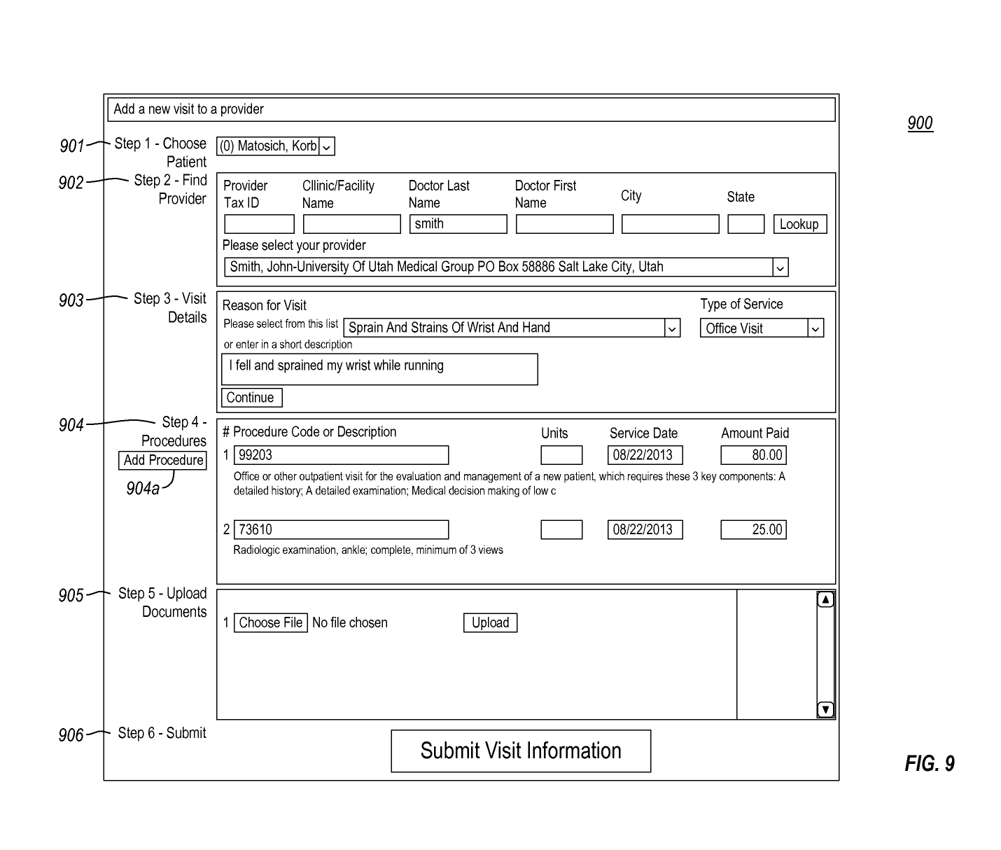

FIG. 2 illustrates one or more additional acts that may be performed as part of act 105. In act 205, one or more user interfaces (e.g., the user interface 900 of FIG. 9) are made available, through which the patient enters information about a recent provider visit or series of visits using any combination of pre-defined menus and free- form text fields. Information obtained from the patient in this act may include one or more of the following:

### 1. Provider Name

### 2. Provider Address

### 3. Date of Service

4. Reason for visit/diagnoses
5. Procedures performed
6. Price paid

Preferably, information is accessed or identified through pre-defined menus, pre-populated fields, look-ups, and field validation. For example, provider name and address may include look up capabilities to easily find in-network providers, the date of service may entered using a calendar widget to avoid inappropriate dates, the diagnoses and procedures may also include look up capabilities to facilitate patients entering the correct clinical information. In another example, the price paid field may validate that a recognizable price had been entered. Such safeguards are useful in avoiding errors in the data entry process, especially when the patient is entering information related to medical terminology with which most patients are not familiar.

In some embodiments, the patient provides information that is included in a clinical summary that was provided to the patient at the time of service. Notably, a clinical summary may be different than conventional invoices or claims that have been previously provided to patients. In particular, clinical summaries may comprise an after-visit summary that provides a patient with relevant and actionable information and/or instructions related to his or her visit. In some embodiments, a clinical summary may include one or more of the following: patient name, provider name, provider office contact information, date of an office visit, location of the office visit, reason for the office visit, current problem list, current medication list, current medication allergy list, procedure(s) performed during the visit, immunizations or medications administered during the visit, vital signs taken during the visit (or other recent vital signs), laboratory test results, list of diagnostic tests pending, clinical instructions, future appointments, referrals to other providers, future scheduled tests, demographic information, smoking status, care plan (including goals and instructions), and/or recommended patient decision aids. With respect to procedure(s) performed during the visit, the clinical summary may list an identification code associated with each procedure. Such codes may correspond to standard insurance codes.

In act 210, the information about each visit or series of visits entered by a patient in act 205 is established in a database as a unique patient group of services. As part of this process, a duplicate check may be performed to prevent information about a specific visit or series of visits from being entered multiple times. This duplicate check may need to evaluate the data to identify near matches as well as exact matches and take the patient through a reconciliation process to avoid duplicate entries.

In act 215, each patient group of services is assigned a unique identifier. The unique identifier is usable to distinguish the group from other patient groups of services, and to link the group to provider groups of services that are established in a subsequent process.

In act 220, each patient group of services is displayed in a tabular format that allows the groups of services to be searched and/or sorted based on any of the information contained in the groups of services. This table may also present the opportunity to the end user to edit information in the groups of services if errors are identified or other changes need to be made.

Returning to FIG. 1, in act 110 information is accessed from the alleged provider(s) about alleged services delivered and prices paid in connection with a recent visit or series of visits entered by a patient in act 105. For example, once a patient has an established group of services in the system that was created in act 105, the alleged provider(s) may be prompted to independently input information about the same visit or series of visits. While act 110 is shown to occur after act 105, it will be appreciated that the information accessed from the provider(s) can actually be accessed prior to, subsequent to, and/or contemporaneously to the accessing of the information from the patient. The ordering of the illustrated act can also be altered, as shown by the path from act 115 to act 110 or act 105, or in any other manner as well.

With respect to ordering of provider vs. patient submissions, for example, a provider may submit information relative to a patient visit (e.g., clinical summary information) at the time of a patient visit. For example, a provider may submit such information via a web page, may submit or make such information available via an electronic data interchange (EDI) interface or other application programming interface (API), or may communicate such information in any other appropriate manual or automatic manner. Thus, when the patient submits the visit data, the provider's information may already exist in the plan administrator's system.

In other embodiments, information about a patient's visit may be matched against financial records, such as records of a health savings account (HSA) or another linked or dedicated financial account. Thus, in some embodiments, act 110 for accessing information from the alleged provider(s) about alleged services delivered and prices paid in connection with a recent visit or series of visits entered by a patient may actually include accessing external information such as HSA information, rather than accessing information expressly entered by a provider.

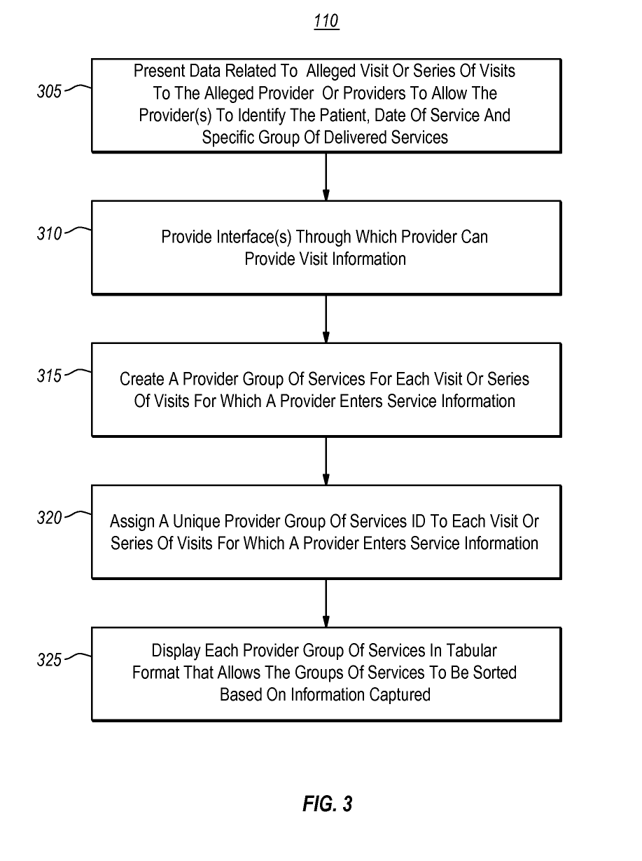

FIG. 3 illustrates one or more additional acts for executing act 110 of FIG. 1. In act 305, the alleged provider(s) are presented data related to the visit or series of visits entered in act 105 by the patient. The information presented to the provider(s) may be a subset of the information provided by the patient, so as to require the provider(s) to independently enter a few key pieces of information as a form of validation. In some embodiments, the provider is given one or more of the following:

### 1. Patient Name

### 2. Date of Service

### 3. Place of Service

Additional information may or may not be provided to the provider, depending on the degree in which double-blind data entry is desired as a validation tool. The information supplied should be usable by the provider(s) to identify the target patient, the date of service, and any services delivered.

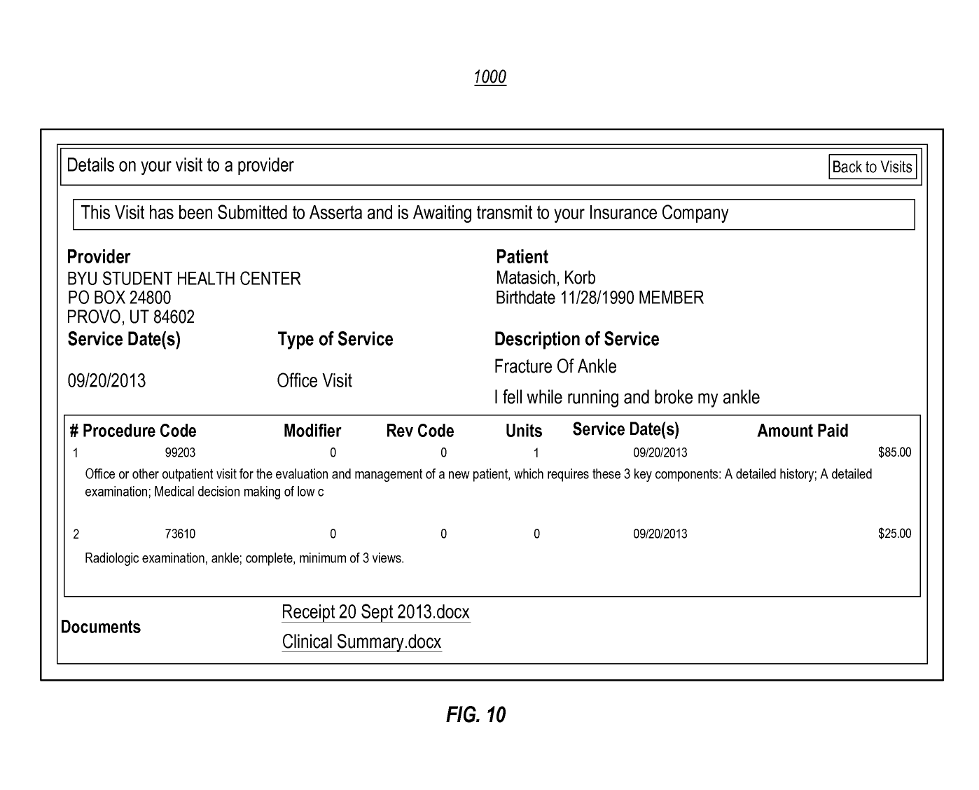

In act 310, one or more interfaces are made available through which the provider provides information about the identified recent provider visit or series of visits. Such interfaces may be user interfaces similar to the patient user interfaces of FIGS. 9 and 10, and which gather the information using pre-defined menus, free form text, etc. Alternatively, such interfaces may include EDI interface(s) or API(s) that programmatically access the information from another provider system or that push the information to another provider system. The information acquired from the provider in this act may include one or more of the following:

1. Reason for visit/diagnoses
2. Procedures performed
3. Price paid

When possible, the information may be accessed or identified by using pre-defined menus, pre-populated fields, look-ups and field validation. For example, diagnoses and procedures may include look up capabilities to facilitate provider staff entering the correct clinical information. The price paid field may validate that a recognizable price had been entered. These safeguards help to avoiding errors in the information identification/accessing processes—especially when non-clinical provider staff is entering information related to medical terminology with which most non-clinical people are not familiar. Without these look-ups and validations (e.g. with a paper process), it may be difficult to identify valid information from the provider without unnecessary clinical involvement.

Act 310 may also provide the provider(s) the opportunity to suggest corrections for data originally entered by the patient. If provider(s) records of the visit or series of visits differ from the patient entered information, the provider(s) may enter alternative values for the data. The entering of suggested corrections by the provider(s) can automatically trigger a reconciliation process to determine if the suggested corrections are material enough to require follow-up with the patient or if the group of services can continue on with normal processing.

In act 315, the information about each visit or series of visits entered by the provider(s) in act 310, is established in a database as a unique provider group of services.

In act 320, each provider group of services is assigned a unique identifier that is usable to distinguish the group from other provider groups of services, and to link the group to patient groups of services, as were described previously.

In act 325, each provider group of services is displayed in a tabular format, which allows the groups of services to be searched and/or sorted based on any of the information contained in the groups of services. This table may also present the opportunity to the end user to edit information in the groups of services if errors are identified or other changes need to be made.

Returning again to FIG. 1, in act 115 the patient supplied information is automatically reconciled with the provider-supplied information (e.g., using logic, fuzzy logic, artificial intelligence, etc.). For example, once both the patient and the provider(s) have entered their respective information related to the visit or series of visits in question, the software system may attempt to determine if the information entered by both parties “match.”

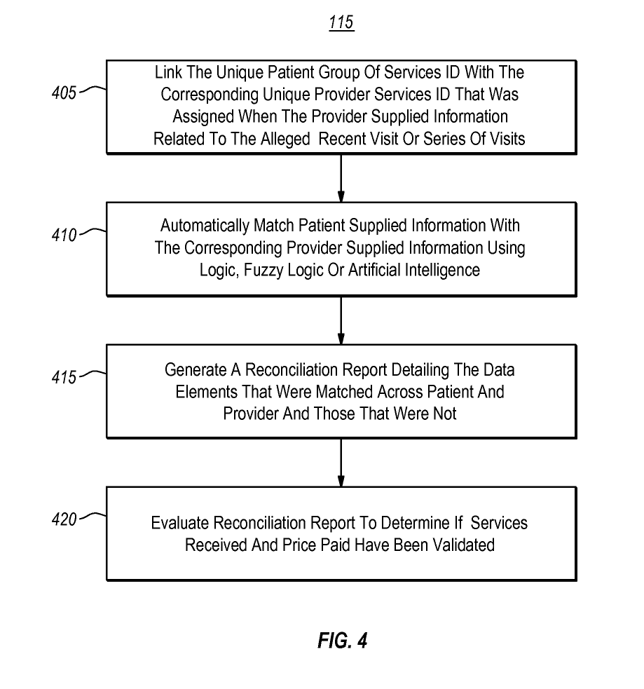

FIG. 4 illustrates one or more additional acts for executing act 115. In act 405, the unique identifier for the patient group of services is linked to the unique identifier for the corresponding provider group of services. The corresponding provider group of services is identified by tracking the patient group of services that were presented to the provider(s) when prompting the provider(s) to supply information or through an automatic process whereby the system would attempt to match “like” groups of services independently created by patients and providers respectively. The ability to edit or break this link may be presented in this act, as well, in the event that the provider(s) supplied the wrong information in response to the presentation of information about a specific patient visit or series of visits or the automatic matching process failed to make a correct match of patient and provider groups of services.

In act 410, the data belonging to the linked unique patient group of services ID may be automatically reconciled with the data belonging to the linked unique provider group of services identifier to determine if the information entered by both parties “match.” This matching may need to accommodate more than simple equivalency testing, since it is possible patients and providers will use similar, but different, descriptions to report the same diagnoses and procedures. The system may also need to intelligently manage slightly different individual dates or date ranges. More complex logic may also need to be applied to pricing, so that only material discrepancies are pursued while minor differences are ignored—so that processing can continue unimpeded.

In act 415, a reconciliation report is generated that details the data elements that were “matched” across the linked groups of services, and those that were not. The report may also include a list of all of the double blind entered data elements and a status as to whether the system succeeded or failed in automatically establishing a match.

In act 420, the reconciliation report is evaluated to determine if a sufficiency of data has been “matched” to appropriately validate the patient's original assertion or the providers immaterially modified assertion of services delivered and price paid. The criteria for establishing sufficiency depend on the data element in question and a specific administrator's tolerance for discrepancies.

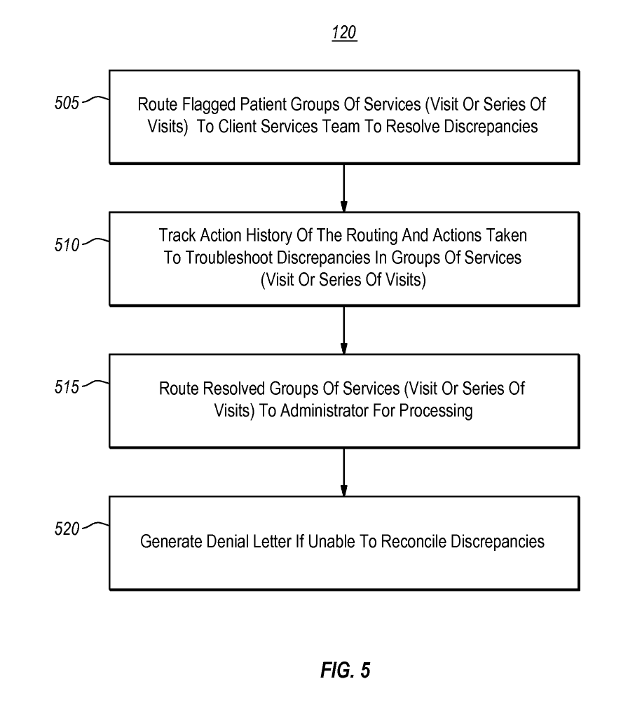

Returning again to FIG. 1, in act 120, a patient group of services that has failed validation is flagged for follow-up so that a client services team can resolve discrepancies. FIG. 5 illustrates one or more additional acts for executing act 120. In act 505, a patient group of services that has failed validation is routed to a resolution queue that the client services team will work to resolve discrepancies. This resolution queue may show all of the patient groups of services that have failed validation, and may flag the specific data elements that are the source of concern. A client services team may then be able to attempt to manually reconcile the discrepancies or follow up with the patient and/or the provider(s) to clarify information.

In act 510, an audit trail is maintained to track all of the routing history and actions taken relative to the patient groups of services. This audit trail may include information about when the groups of services were created, edited, routed to specific work queues, etc.

If discrepancies are resolved, in act 515, patient groups of services are routed to the plan administrator for further processing. If discrepancies cannot be resolved, then a denial letter may be generated for the patient in act 520.

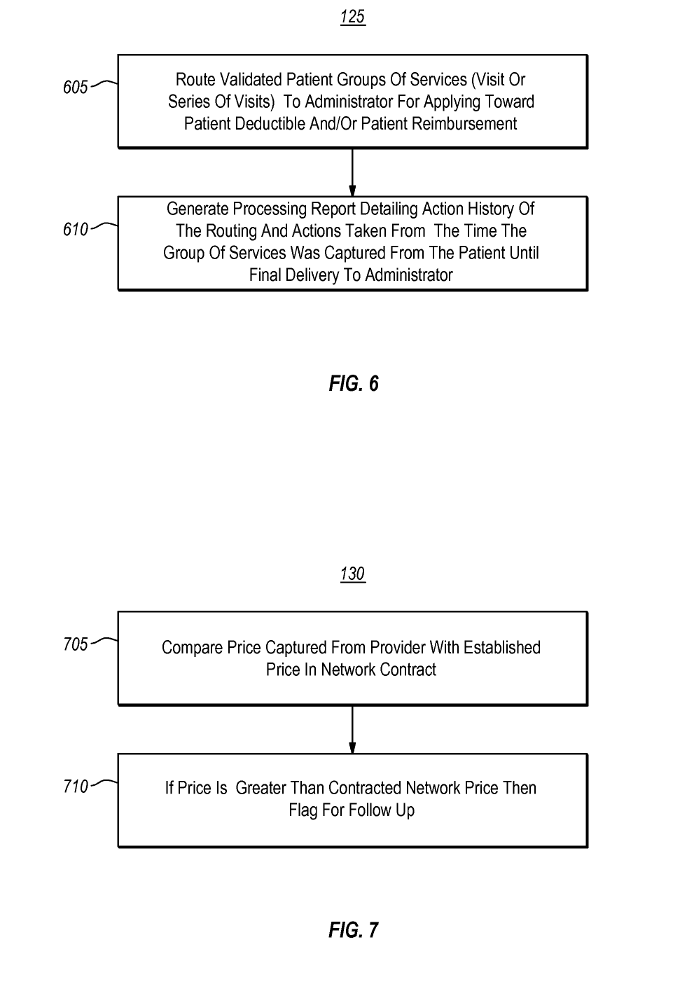

Returning again to FIG. 1, in act 125 a patient group of services that has been validated is routed to a plan administrator for further processing. FIG. 6 illustrates one or more additional acts for executing act 125. In act 605, a patient group of services that has been validated is routed to the plan administrator in order to apply the price paid in connection with that patient group of services toward the patient deductible and/or patient reimbursement.

In act 610, a processing report is created that tracks routing history and actions taken relative to the patient groups of services. This audit trail may include information about when the groups of services were created, edited, routed to specific work queues, etc.

Returning once again to FIG. 1, in act 130 the price charged by the provider(s) is compared with the established price in the network contract to ensure that it is less than or equal to the network price. FIG. 7 illustrates one or more additional acts for executing act 130. In act 705, the price entered by the provider in act 110, and subsequently stored in the provider group of services, is compared with the established price agreed upon in the network contract. If the price is less than or equal to the network price, then no action is taken. If the price is greater than the network price, then in act 710, the provider group of services is flagged for manual follow-up by a network management team.

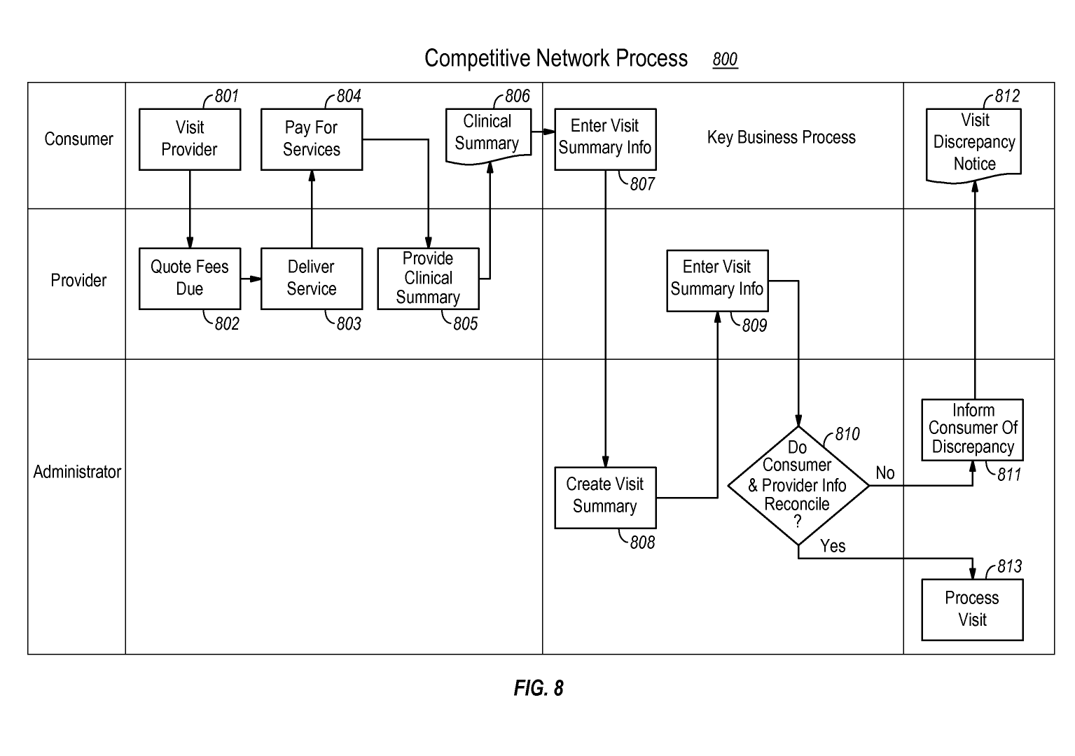

FIG. 8 provides a flow diagram that illustrates many of the processes described above for validating services received and prices paid by patients, and for validating provider pricing compliance with network contracts, and which does not require provider claim submission or provider claim validation. As depicted, a consumer visits a provider (801), and the provider quotes fees due (802) for service(s) requested by the patient. The provider delivers the services (803), and the consumer pays for the service(s) (804) at the time of service. The provider provides the consumer a clinical summary (806) summarizing the visit, including services provided and amounts paid.

Subsequently, the consumer enters visit summary info (807) at a processing system, such as a system (e.g., a web- or cloud-based system) operated by a plan administrator. The plan administrator may be an insurance company, or a third-party processor that processes claims on behalf of one or more insurers. Based on the consumer entering the visit summary info, a visit summary (808) is created. The plan administrator may prompt or otherwise receive visit summary information (809) from the provider, and determine whether the consumer-provided information and the provider-provided information reconcile (810). If the information does not reconcile, the plan administrator can inform the consumer of the discrepancy (811) through a visit discrepancy notice (812). If, on the other hand, the information reconciles, the plan administrator can process the visit (813), such as by applying the amounts paid by the consumer to the consumer's insurance deductible, by issuing a refund, etc.

As mentioned previously, the provider may enter visit summary information prior to the consumer entering the summary information, or the plan administrator may obtain visit summary information from an external source, such as from an HSA Account Administrator (bypassing the provider, or supplementing information obtained from the provider).

FIGS. 9 and 10 illustrate some example consumer-facing user interfaces for entering visit information, according to one or more embodiments. Such user interfaces may, for example, be used in connection with act 105 of FIG. 1, for accessing information from patients documenting services received and prices paid in connection with a recent provider visit or series of visits for which the patient paid at the time of service. Such user interfaces may also be used for item 807 in the flow diagram of FIG. 8 for validating services received and prices paid by patients.

FIG. 9 illustrates a user interface 900 for entry of patient visit information. The user interface 900 of FIG. 9 includes a user interface control or controls 901 in which a user specifies a patient to which services were provided. The user interface control 901 may be free form or, as depicted, include a selectable (e.g., dropdown) menu of valid patients (e.g., patients associated with a current user identifier, current insurance plan, etc.).

The user interface 900 of FIG. 9 also includes a user interface control or controls 902 in which a user specifies a provider that provided one or more services to the patient specified in control(s) 901, which services the patient paid for at the time of service. In the depicted user interface, example, the control(s) 902 include a plurality of lookup fields in which a provider may be queried for using one or more of provider tax identifier, clinic/facility name, doctor name, city, or state. Control(s) 902 may include any combination of user interface controls that enable entry or selection of a provider, or lookup of a provider from one or more databases.

The user interface 900 of FIG. 9 also includes a user interface control or controls 903 for providing visit details. As depicted, visit details can include a reason for visit (e.g., a plain-language description, a type of diagnosis, and additional comments). As depicted, the details gathered by control(s) 903 can include any combination of free-form text entry, pre-populated fields, drop down menus, etc.

The user interface 900 of FIG. 9 also includes a user interface control or controls 904 for specifying one or more procedures performed by the provider for the patient during one or more visits. For example, data collected may include a procedure code or description, a number of units (if applicable), a service date, and an amount paid for each procedure. The number of units may apply when a particular procedure can be applied multiple times. For example, if the procedure is mole removal, the number of units may be the number of moles removed. Generally, the data entered may be obtained by the user from a clinical summary or other documentation provided to the patient by the provider at the time of service. In some embodiments, the procedure code corresponds to standard procedure codes used by the health insurance industry. The control(s) 904 can enable entry of multiple procedures and/or visits. For example the depicted “add procedure” button 904a enables the addition of data fields for additional procedures.

The user interface 900 of FIG. 9 also includes a user interface control or controls 905 for the uploading of one or more relevant documents. For example a user may upload a copy of a credit card statement or receipt, a clinical summary, or any other documentation that can be used as evidence of the visit, the procedure(s) performed, and/or an amount of money paid at the time of service.

The user interface 900 of FIG. 9 also includes a user interface control or controls 906 for submission of any entered data. Upon submission of the entered data, a visit summary (e.g., 808 in FIG. 8) may be created and/or displayed to the user. For example, FIG. 10 illustrates and example of a user interface 1000 that presents visit summary information. As depicted in the user interface 1000, visit summary information may include a summary of the data that was entered in the user interface 900. In some embodiments, the user interface 1000 enables the user to edit or modify one or more pieces of information, or to cancel the claim altogether.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

In its most basic configuration, a computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In this description, embodiments have been described with reference to acts that are performed by one or more computing systems. If such acts are implemented in software, one or more processors of the associated computing system that performs the acts direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over, for example, a network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory”, and includes memory locations that are addressable by the at least one processing unit over a memory bus in which case the address location is asserted on the memory bus itself. System memory has traditionally been volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The present invention may be embodied in other specific forms without departing from its spirit or essential characteristics. The described embodiments are to be considered in all respects only as illustrative and not restrictive.

What is claimed:

1. One or more hardware storage devices having stored thereon computer-executable instruction that, when executed at one or more processors of a computer system, cause the computer system to implement a method for validating services received and prices paid by a patient, including the following:
presenting a patient user interface that is configured to enable a patient to enter patient information relative to medical services received by the patient in connection with one or more visits by the patient to a medical provider;
receiving, at the patient user interface, the patient information, the patient information including at least the following:
(i) an identity of at least one service provided to the patient by the medical provider; and
(ii) a price paid by the patient to the medical provider in connection with the medical provider providing the at least one service to the patient; and
determining, based on the patient information, one or both of (i) whether or not the price paid by the patient is applicable toward a deductible for the patient's insurance plan, or (ii) whether or not all or part of the price paid by the patient is applicable toward a patient reimbursement based on the patient's insurance plan.

2. The one or more hardware storage devices of claim 1, wherein the patient information received at the patient user interface also includes one or more of the following: a provider name, a provider address, a date of service, a reason for visit, a diagnosis, or a procedure performed.

3. The one or more hardware storage devices of claim 1, further comprising verifying whether all or a portion of the patient information has already been received.

4. The one or more hardware storage devices of claim 1, further comprising:
accessing provider information relative to medical services provided by the medical provider in connection with the one or more visits by the patient to the medical provider; and
reconciling the patient information with the provider information to validate whether or not the provider provided the least one service and that the patient paid the price.

5. The one or more hardware storage devices of claim 4, wherein accessing the provider information comprises one of:
prompting the medical provider to provide the provider information subsequent to receiving the patient information;
receiving the provider information from the medical provider prior to receiving the patient information; or
receiving the provider information from the medical provider contemporaneously with receiving the patient information.

6. The one or more hardware storage devices of claim 4, wherein it is determined that the price paid by the patient is applicable toward a deductible for the patient's insurance plan, and/or that part of the price paid by the patient is applicable toward a patient reimbursement based on the patient's insurance plan based on the validating indicating that the provider did provide the least one service and that the patient did pay the price that was indicated in the patient information.

7. The one or more hardware storage devices of claim 4, wherein it is determined that the price paid by the patient is not applicable toward a deductible for the patient's insurance plan, and/or that part of the price paid by the patient is not applicable toward a patient reimbursement based on the patient's insurance plan based on the validating indicating that the provider did not provide the least one service or that the patient did not pay the price that was indicated in the patient information.

8. The one or more hardware storage devices of claim 4, wherein accessing provider information relative to medical services provided by the medical provider includes presenting a provider interface through which the provider can provide the provider information.

9. The one or more hardware storage devices of claim 4, wherein reconciling the patient information with the provider information comprises an automatic reconciliation.

10. The one or more hardware storage devices of claim 4, wherein reconciling the patient information with the provider information comprises a manual reconciliation.

11. One or more hardware storage devices having stored thereon computer-executable instruction that, when executed at one or more processors of a computer system, cause the computer system to implement a method for validating services received and prices paid by a patient, including the following:
presenting a patient user interface that is configured to enable a patient to enter patient information relative to medical services received by the patient in connection with one or more visits by the patient to a medical provider;
receiving, at the patient user interface, the patient information, the patient information including at least the following:
(i) an identity of at least one service provided to the patient by the medical provider; and
(ii) a price paid by the patient to the medical provider in connection with the medical provider providing the at least one service to the patient;
accessing provider information relative to medical services provided by the medical provider in connection with the one or more visits by the patient to the medical provider; and
determining, based on the patient information and the provider information, one or both of (i) whether or not the price paid by the patient is applicable toward a deductible for the patient's insurance plan, or (ii) whether or not all or part of the price paid by the patient is applicable toward a patient reimbursement based on the patient's insurance plan.

12. The one or more hardware storage devices of claim 11, wherein the patient information received at the patient user interface also includes one or more of the following: a provider name, a provider address, a date of service, a reason for visit, a diagnosis, or a procedure performed.

13. The one or more hardware storage devices of claim 11, further comprising verifying whether all or a portion of the patient information has already been received.

14. The one or more hardware storage devices of claim 11, further comprising reconciling the patient information with the provider information to validate whether or not the provider provided the least one service and that the patient paid the price.

15. The one or more hardware storage devices of claim 14, wherein it is determined that the price paid by the patient is applicable toward a deductible for the patient's insurance plan, and/or that part of the price paid by the patient is applicable toward a patient reimbursement based on the patient's insurance plan based on the validating indicating that the provider did provide the least one service and that the patient did pay the price that was indicated in the patient information.

16. The one or more hardware storage devices of claim 14, wherein it is determined that the price paid by the patient is not applicable toward a deductible for the patient's insurance plan, and/or that part of the price paid by the patient is not applicable toward a patient reimbursement based on the patient's insurance plan based on the validating indicating that the provider did not provide the least one service or that the patient did not pay the price that was indicated in the patient information.

17. The one or more hardware storage devices of claim 14, wherein accessing provider information relative to medical services provided by the medical provider includes presenting a provider interface through which the provider can provide the provider information.

18. The one or more hardware storage devices of claim 14, wherein reconciling the patient information with the provider information comprises one or both of a manual reconciliation or an automatic reconciliation.

19. The one or more hardware storage devices of claim 11, wherein accessing the provider information comprises one of:
prompting the medical provider to provide the provider information subsequent to receiving the patient information;
receiving the provider information from the medical provider prior to receiving the patient information; or
receiving the provider information from the medical provider contemporaneously with receiving the patient information.

20. A computer system, comprising:
one or more hardware processors; and
one or more computer-readable media having stored thereon computer-executable instructions that, when executed by one the one or more processors, cause the computer system to perform the following:
presenting a patient user interface that is configured to enable a patient to enter patient information relative to medical services received by the patient in connection with one or more visits by the patient to a medical provider;
receiving, at the patient user interface, the patient information, the patient information including at least the following:
(i) an identity of at least one service provided to the patient by the medical provider; and
(ii) a price paid by the patient to the medical provider in connection with the medical provider providing the at least one service to the patient;
accessing provider information relative to medical services provided by the medical provider in connection with the one or more visits by the patient to the medical provider; and
determining, based on the patient information and the provider information, one or both of (i) whether or not the price paid by the patient is applicable toward a deductible for the patient's insurance plan, or (ii) whether or not all or part of the price paid by the patient is applicable toward a patient reimbursement based on the patient's insurance plan.
